(19) United States
(12) Patent Application Publication
(10) Pub. No.: US 2017/0114987 A1
(43) Pub. Date: Apr. 27, 2017

(54) ILLUMINATION CEILING LAMP AND LAME CAP THEREOF

(71) Applicant: DONGGUAN YINGHUI LIGHTING CO., LTD., Dongguan (CN)

(72) Inventor: Shuisheng XU, Dongguan (CN)

(21) Appl. No.: 15/334,403

(22) Filed: Oct. 26, 2016

(30) Foreign Application Priority Data
Oct. 26, 2015 (CN) 201520843575.X

(51) Int. Cl. F21V 17/16; F21V 23/00; F21S 8/06

(52) U.S. Cl. CPC F21V 17/16; F21S 8/063; F21V 23/002; F21V 1/00

(57) ABSTRACT

The illumination ceiling lamp comprises a mounting base, the lamp cap, a lamp cap cover, a lampshade, snap rings and a power wire, wherein the lower end of the power wire is connected to the lamp cap; the upper end of the power wire penetrates through the lamp cap cover and is connected into the mounting base; the snap rings are connected to the lamp cap by threads; the lampshade covers the lamp cap; and the snap rings are configured to limit the lampshade. The lamp cap comprises a lamp holder and an illumination lamp, wherein the illumination lamp is arranged on one end surface of the lamp holder; the lamp holder is cylindrical; the outside surface of the lamp holder is provided with outer threads in a raised manner; the other end surface of the lamp holder is provided with a mounting hole into which the power wire penetrates.

### FIELD OF THE INVENTION

The present patent relates to a lamp, in particular to an illumination ceiling lamp convenient to mount and a lamp cap thereof.

### BACKGROUND OF THE INVENTION

In the prior art, when an illumination ceiling lamp is in use, a lamp cap portion thereof is generally exposed in air, it is inevitable to cause dust accumulation outside the lamp cap as time goes on, thereby affecting normal glowing and brightening of the lamp cap, and therefore, more illumination ceiling lamps with lamp caps and lampshades arise in the market. The upper end of the lampshade is fixedly connected to the lamp cap of the illumination ceiling lamp by snap rings, and the lamp cap portion of the illumination ceiling lamp is positioned in the glass lampshade. Because the lamp cap is connected to the lampshade in a non-detachable manner, it is very inconvenient to disassemble, assemble ad clean the lamp cap and the lampshade. If the lamp cap and the lampshade are disassembled forcedly, the snap rings or the lampshade and the lamp cap will be damaged. Moreover, a lampshade or other accessories of a traditional ceiling lamp can only be mounted from one end of the lamp holder, and once one accessory is assembled by mistake, it is necessary to take the accessory and elements except the accessory out and reinstall them, thus bringing inconvenience.

### SUMMARY OF THE INVENTION

On this basis, it is necessary to provide an illumination ceiling lamp convenient to assemble and disassemble against the defects in the prior art.

A lamp cap comprises a lamp holder and an illumination lamp, wherein the illumination lamp is arranged on one end of the lamp holder, the lamp holder is cylindrical, and the outside surface of the lamp holder is provided with outer threads in a raised manner and one or more sections which extend from the top end to the bottom end of the lamp holder.

Further, the upper end surface of the lamp holder is provided with a mounting hole.

Further, the number of the sections on the outside surface of the lamp holder is two, and the two sections on the outside surface of the lamp holder are arranged symmetrically.

An illumination ceiling lamp comprises the lamp cap, a lamp cap cover, a lampshade and snap rings, wherein the snap rings are connected to the lamp cap by threads, the lampshade covers the lamp cap, the snap rings are configured to limit the lampshade, and the lamp cap cover covers the lamp cap; and the lamp cap comprises a lamp holder and an illumination lamp, wherein the illumination lamp is arranged on one end of the lamp holder, the lamp holder is cylindrical, and the outside surface of the lamp holder is provided with outer threads in a raised manner and is provided with one or more sections which extend from the top end to the bottom end of the lamp holder.

Further, the other end surface of the lamp holder is provided with a mounting hole.

Further, the illumination ceiling lamp further comprises a boom, a power wire and a mounting base, wherein the upper end and the lower end of the boom are connected to the mounting base and the lamp cap cover respectively, the power wire penetrates into the boom, the upper end of the power wire is connected to the mounting base, and the lower end of the power wire penetrates into the mounting hole of the lamp holder.

Further, each snap ring is arranged hollowly, and the inside surface of the snap ring is concavely provided with inner threads which are matched with the outer threads on the lamp holder.

Further, the outside surface of the lamp holder is provided with two sections symmetrically.

Further, a limiting portion is arranged on the lampshade and is provided with a mounting hole into which the lamp holder is installed, wherein one end, close to the illumination lamp, of the lamp holder extends into the lampshade, and the other end thereof extends out of the lampshade.

Further, the lampshade is arranged in a horn shape.

Compared with the prior art, the illumination ceiling lamp of the present patent is provided with the lampshade, the lamp cap and the snap rings, wherein the lampshade is sleeved on the lamp cap, and the snap rings are connected to the lamp cap by threads and configured to limit the lampshade. This illumination ceiling lamp is simple in structure and easy to disassemble and assemble. Spare and accessory parts may be replaced conveniently. Due to the design of the lamp cap, the snap rings, the lampshade and other accessories may be installed freely from any end of the lamp cap, such that the illumination ceiling lamp is installed more conveniently.

### BRIEF DESCRIPTION OF THE DRAWINGS

FIG. 1 is a structural schematic drawing of embodiment 1 of the illumination ceiling lamp of the present patent;

FIG. 2 is a structural schematic drawing when the power wire is connected to the lamp cap as shown in FIG. 1;

FIG. 3 is a structural schematic drawing of the lamp cap as shown in FIG. 1;

FIG. 4 is a top view of the lamp cap as shown in FIG. 3;

FIG. 5 is a structural schematic drawing of a lamp cap in embodiment 2 of the illumination ceiling lamp of the present patent;

FIG. 6 is a top view of the lamp cap as shown in FIG. 5;

FIG. 7 is a structural schematic drawing of a lamp cap in embodiment 3 of the illumination ceiling lamp of the present patent; and

FIG. 8 is a top view of the lamp cap as shown in FIG. 7.

### DETAILED DESCRIPTION OF THE PREFERRED EMBODIMENTS

To make the purpose, the technical solution and the advantages of the present patent understood more clearly, the present patent will be described in details as below in conjunction with the drawings and the embodiments.

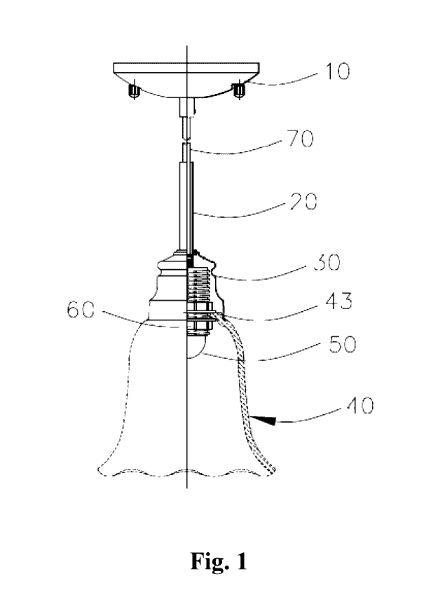

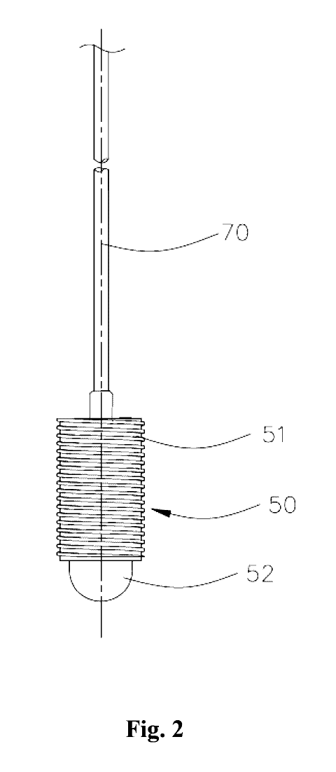

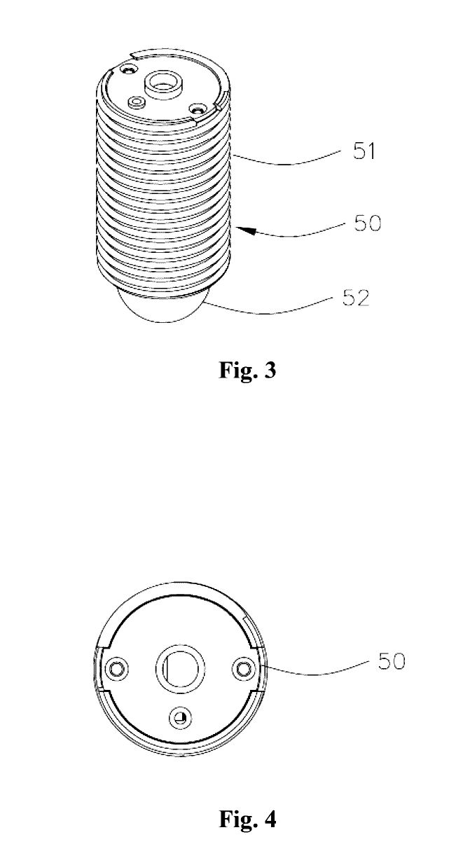

FIGS. 1-4 illustrate the embodiment 1 in the illumination ceiling lamp of the present patent. The illumination ceiling lamp comprises a mounting base 10, a boom 20, a lamp cap cover 30, a lampshade 40, a lamp cap 50, snap rings 60 and a power wire 70, wherein the lower end of the boom 20 is assembled on the lamp cap cover 30, the upper end of the boom 20 is fixed to the mounting base 10, the power wire 70 penetrates into the boom 20, and the lower end of the power wire 70 is connected to the lamp cap 50. The upper end of the power wire 70 penetrates through the lamp cap cover 30 and is connected into the mounting base 10. The snap rings 60 are connected to the lamp cap 50 and are configured to limit the lamp cap 40, and the lampshade 40 covers the lamp cap 50.

The lampshade 40 is designed in a horn shape, one end thereof being an open end of the horn, and the other end thereof being provided with a limiting portion 41. The limiting portion 41 is provided with a mounting hole. The lampshade 40 is sleeved on the lamp cap 50. The snap rings 60 are connected to the lamp cap 50 at two sides of the mounting hole by threads so as to fix the lampshade 40.

The lamp cap 50 comprises a lamp holder 51 and an illumination lamp 52, wherein the illumination lamp 52 is arranged on the top end of the lamp holder 51, and a lateral dimension of the illumination lamp 52 is not greater than that of the lamp holder 51, such that the snap rings 60 can be mounted smoothly from one end of the illumination lamp 52. The other end, away from the illumination lamp 52, of the lamp cap 51 is provided with a mounting hole, and the power wire 70 penetrates into the mounting hole. The lamp holder 51 penetrates into the mounting hole in the limiting portion 41 of the lampshade 40. One end, which is provided with the power wire 50, of the lamp holder 51 extend into the lamp cap cover 30, and one end, which is provided with the illumination lamp 52, of the lamp holder 51 extends into the lampshade 40. The lamp holder 51 is cylindrical, and outer threads are arranged on the surface around the lamp holder 51.

Each snap ring 60 is tubular. The inside surface of each snap ring 60 is provided with inner threads which are matched with the outer threads of the lamp holder 51. The snap rings 60 may be mounted from any end of the lamp holder 51 and are respectively fixed to the lamp holder 51 at two sides of the limiting portion 41, such that the lampshade 40 can be fixed to the lamp holder 51 more stably.

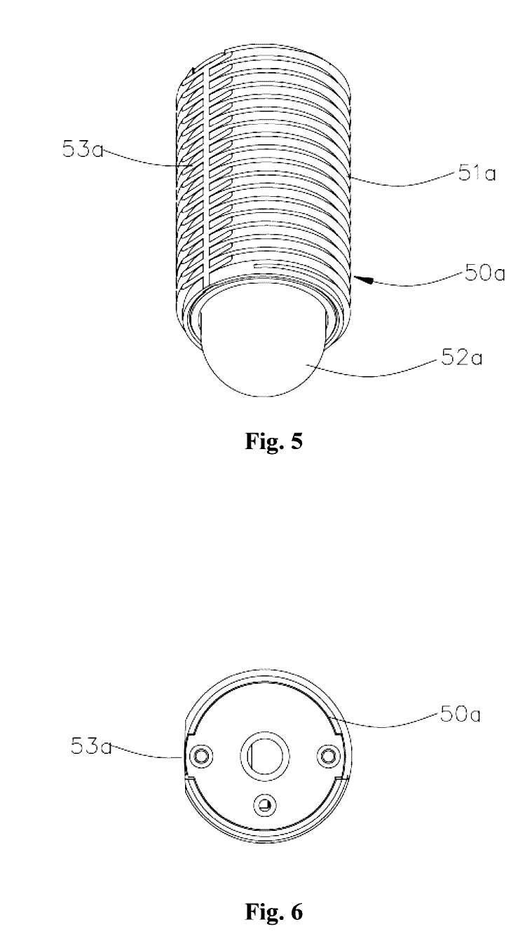

FIG. 5 and FIG. 6 illustrate the embodiment 2 in the illumination ceiling lamp of the present patent. Similar to the embodiment 1, the illumination ceiling lamp in this embodiment also comprises a mounting base 10, a boom 20, a lamp cap cover 30, a lampshade 40, a lamp cap 50a, snap rings 60 and a power wire 70, the lamp cap 50a comprising a lamp holder 51a and an illumination lamp 52a, and differs from the embodiment 1 in that: the outside surface of the lamp holder 51a is provided with a section 53a which extends from the top end to the bottom end of the lamp holder 51a. It may be understood that the section 53a may be a groove. Due to the arrangement of the section 53a, a notch is formed between the inside surface of the snap ring 60 and the outside surface of the lamp holder 51a, thereby facilitating heat radiation of the ceiling lamp and prolonging the service life of the ceiling lamp.

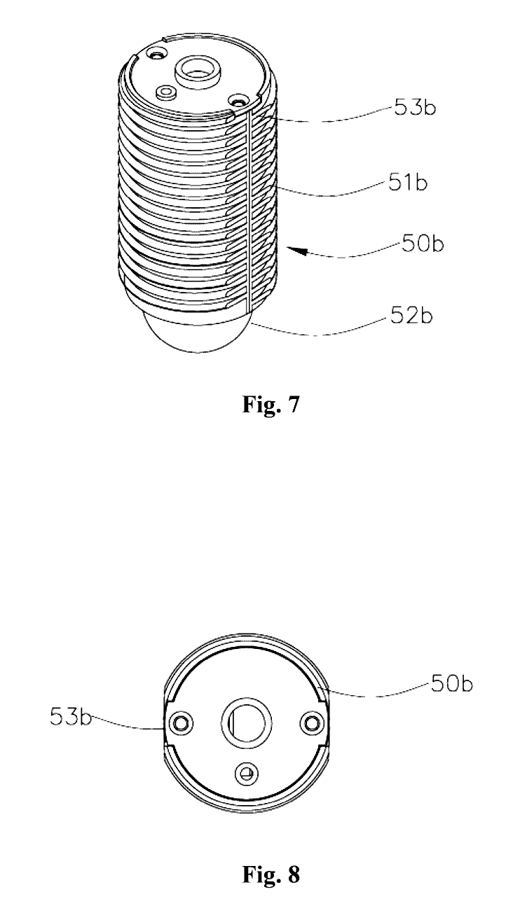

FIG. 7 and FIG. 8 illustrate the embodiment 3 in the illumination ceiling lamp of the present patent. Similar to the embodiment 2, the illumination ceiling lamp in this embodiment also comprises a mounting base 10, a boom 20, a lamp cap cover 30, a lampshade 40, a lamp cap 50b, snap rings 60 and a power wire 70, the lamp cap 50a comprising a lamp holder 51b and an illumination lamp 52b and the lamp holder 51b being provided with sections 53b, and differs from the embodiment 1 in that: the outside surface of the lamp holder 51b is provided with two sections 53b which are arranged symmetrically.

From the above, the illumination ceiling lamp of the present patent is provided with the lampshade 40, the lamp cap 50 and the snap rings 60, wherein the lampshade 40 is sleeved on the lamp cap 50, and the snap rings 60 are connected to the lamp cap 50 by threads and configured to limit the lampshade 40. This illumination ceiling lamp is simple in structure and easy to disassemble and assemble. Spare and accessory parts may be replaced conveniently. Due to the design of the lamp cap 50, the snap rings 60, the lampshade 40 and other accessories may be installed freely from any end of the lamp cap 50, such that the illumination ceiling lamp is installed more conveniently.

The above embodiments just express one implementation of the present patent, and the description is more specific and detailed, but will not be interpreted to limit the patent scope of the present patent. It should be noted that those skilled in the art may also make several variations and improvements on the premise of not departing from the conception of the present patent, all of which belong to the protection scope of the present patent. Therefore, the patent protection scope of the present patent should be subject to the attached claims.

What is claimed is:

1. A lamp cap, comprising a lamp holder and an illumination lamp, wherein the illumination lamp is arranged on one end of the lamp holder, the lamp holder is cylindrical, and the outside surface of the lamp holder is provided with outer threads in a raised manner and one or more sections which extend from the top end to the bottom end of the lamp holder.

2. The lamp cap according to claim 1, wherein the upper end surface of the lamp holder is provided with a mounting hole.

3. The lamp cap according to claim 1, wherein the number of the sections on the outside surface of the lamp holder is two, and the two sections on the outside surface of the lamp holder are arranged symmetrically.

4. An illumination ceiling lamp, comprising a lamp cap, a lamp cap cover, a lampshade and snap rings, wherein the snap rings are connected to the lamp cap by threads, the lampshade covers the lamp cap, the snap rings are configured to limit the lampshade, and the lamp cap cover covers the lamp cap; and the lamp cap comprises a lamp holder and an illumination lamp, wherein the illumination lamp is arranged on one end of the lamp holder, the lamp holder is cylindrical, and the outside surface of the lamp holder is provided with outer threads in a raised manner and is provided with one or more sections which extend from the top end to the bottom end of the lamp holder.

5. The illumination ceiling lamp according to claim 4, wherein the other end surface of the lamp holder is provided with a mounting hole.

6. The illumination ceiling lamp according to claim 4, wherein the illumination ceiling lamp further comprises a boom, a power wire and a mounting base, wherein the upper end and the lower end of the boom are connected to the mounting base and the lamp cap cover respectively, the power wire penetrates into the boom, the upper end of the power wire is connected to the mounting base, and the lower end of the power wire penetrates into the mounting hole of the lamp holder.

7. The illumination ceiling lamp according to claim 4, wherein each snap ring is arranged hollowly, and the inside surface of the snap ring is concavely provided with inner threads which are matched with the outer threads on the lamp holder.

8. The illumination ceiling lamp according to claim 4, wherein the outside surface of the lamp holder is provided with two sections symmetrically.

9. The illumination ceiling lamp according to claim 4, wherein a limiting portion is arranged on the lampshade and is provided with a mounting hole in which the lamp holder is installed, wherein one end, close to the illumination lamp, of the lamp holder extends into the lampshade, and the other end thereof extends out of the lampshade.

10. The illumination ceiling lamp according to claim 4, wherein the lampshade is arranged in a horn shape.
